(19) United States
(12) Patent Application Publication
(10) Pub. No.: US 2026/0091780 A1
(43) Pub. Date: Apr. 2, 2026

(54) SYSTEMS AND METHODS FOR LIDAR-BASED AUTONOMOUS VEHICLE CONTROL

(71) Applicant: Glydways Inc., South San Francisco, CA (US)

(72) Inventors: Chor Hei Ernest Cheung, Zephyr Cove, NV (US); Azar Fazel, San Jose, CA (US); Aishanou Osha Rait, Seattle, WA (US); Samvruta Tumuluru, New York, NY (US); Farshid Moussavi, Oakland, CA (US)

(21) Appl. No.: 19/344,022

(22) Filed: Sep. 29, 2025

Related U.S. Application Data
(60) Provisional application No. 63/700,475, filed on Sep. 27, 2024.

(51) Int. Cl. B60W 30/09; G01S 17/89; G01S 17/931; G06T 15/08

(52) U.S. Cl. CPC B60W 30/09; G01S 17/89; G01S 17/931; G06T 15/08; B60W 2554/4041

(57) ABSTRACT

A vehicle may include a set of wheels, a propulsion system coupled to at least a subset of the set of wheels and configured to propel the vehicle, a steering system coupled to at least a subset of the set of wheels and configured to steer the vehicle, and a braking system configured to decelerate the vehicle. The vehicle may also include a light detection and ranging (LiDAR) emitter configured to emit light into an environment external to the vehicle and a LiDAR sensor configured to receive portions of the emitted light reflected by the environment, and a processing system configured to accept, as input, a LiDAR point cloud.

### CROSS-REFERENCE TO RELATED APPLICATION

This application is a nonprovisional patent application of and claims the benefit under 35 U.S.C. § 119 (e) of U.S. Provisional Patent Application No. 63/700,475, filed Sep. 27, 2024, and titled “Voxel Feature Extraction for Object Detection in Autonomous Vehicle Operation,” the contents of which are incorporated herein by reference in its entirety.

### TECHNICAL FIELD

The described embodiments relate generally to transportation systems, and, more particularly, to transportation systems that incorporate light detection and ranging (LiDAR) systems into vehicles in an operational environment.

### BACKGROUND

Vehicles, such as cars, trucks, vans, buses, trams, and the like, are ubiquitous in modern society. Cars, trucks, and vans are frequently used for personal transportation to transport relatively small numbers of passengers, while buses, trams, and other large vehicles are frequently used for public transportation. Vehicles may also be used for package transport or other purposes. Such vehicles may be driven on roads, which may include surface roads, bridges, highways, overpasses, or other types of vehicle rights-of-way. Driverless or autonomous vehicles may relieve individuals of the need to manually operate the vehicles for their transportation needs.

### SUMMARY

A vehicle may include a set of wheels, a propulsion system coupled to at least a subset of the set of wheels and configured to propel the vehicle, a steering system coupled to at least a subset of the set of wheels and configured to steer the vehicle, and a braking system configured to decelerate the vehicle. The vehicle may also include a light detection and ranging (LiDAR) emitter configured to emit light into an environment external to the vehicle and a LiDAR sensor configured to receive portions of the emitted light reflected by the environment, and a processing system configured to accept, as input, a LiDAR point cloud.

The LiDAR point cloud may include points corresponding to respective received portions of the emitted light reflected by the environment. The processing system may identify a set of points of the LiDAR point cloud that are within a three-dimensional region of the environment, generate a voxel direction feature using a respective position value of each point within a first collection of the set of points, generate one or more voxel intensity features using a respective intensity value of each point within a second collection of the set of points, perform a downsampling operation to obtain a third collection of points of the set of points, and generate an augmented LiDAR voxel corresponding to the three-dimensional region of the environment including the voxel direction feature, the one or more voxel intensity features, and the third collection of points.

The processing system may identify, using the augmented LiDAR voxel, a characteristic of the environment, and adjust an operation of at least one of the propulsion system, the steering system, or the braking system in response to identifying the characteristic of the environment. In some embodiments, each of the first collection of the set of points and the second collection of the set of points may each include a greater quantity of points than the third collection of the set of points. In some embodiments, the first collection of the set of points and the second collection of the set of points each comprise each point in the set of points.

In some embodiments, the one or more voxel intensity features may include an intensity distribution feature, and an intensity deviation feature. The three-dimensional region may be defined by a boundary defining a rectangular prism, and the augmented LiDAR voxel may be a column voxel defined by the boundary. In some embodiments, identifying the characteristic of the environment includes using one or more additional augmented LiDAR voxels corresponding to one or more additional three-dimensional regions of the environment. Identifying the characteristic of the environment may include identifying a presence of an object in the environment that is within a predicted path of the vehicle

A vehicle may include a set of wheels, a propulsion system coupled to at least a subset of the set of wheels and configured to propel the vehicle, a steering system coupled to at least a subset of the set of wheels and configured to steer the vehicle, and a braking system configured to decelerate the vehicle. The vehicle may also include a light detection and ranging (LiDAR) emitter configured to emit light into an environment external to the vehicle and a LiDAR sensor configured to receive portions of the emitted light reflected by the environment, and a processing system configured to accept, as input, a LiDAR point cloud, the LiDAR point cloud including points corresponding to respective received portions of the emitted light reflected by the environment.

The processing system may be configured to identify a set of points of the LiDAR point cloud that are within a three-dimensional region of the environment, generate, using the set of points, an intensity feature representative of surface reflectances within the three-dimensional region, generate, using the set of points, a direction feature representative of surface geometries within the three-dimensional region, and perform a downsampling operation to obtain a collection of points within the set of points. The processing system may also be configured to generate, using the intensity feature, the direction feature, and the collection of points, an augmented LiDAR voxel, identify, using the augmented LiDAR voxel, a characteristic of the environment, and adjust an operation of at least one of the propulsion system, the steering system, or the braking system in response to identifying the characteristic of the environment.

In some embodiments, identifying the characteristic of the environment may include providing the augmented LiDAR voxel as input to an environment analysis model and receiving, from the environment analysis model, an identification of the characteristic of the environment. In some embodiments, adjusting the operation of at least one of the propulsion system, the steering system, or the braking system in response to identifying the characteristic of the environment may include determining that the characteristic of the environment is an obstacle positioned in a path of the vehicle, generating a vehicle control instruction configured to alter the path of the vehicle such that the obstacle is no longer positioned in the path, and providing the vehicle control instruction to at least one of the propulsion system, the steering system, or the braking system. The environment analysis model may include a machine learning model trained using sets of training data including historical augmented voxels having annotations identifying environmental characteristics corresponding to the historical augmented voxels.

In some embodiments, identifying the characteristic of the environment may include using one or more additional augmented LiDAR voxels associated with additional respective three-dimensional regions of the environment. In some embodiments, the intensity feature may include a histogram of point intensities generated using the set of points of the LiDAR point cloud. In some embodiments, the downsampling operation may include a stochastic discard operation.

A method for operating a vehicle having a LiDAR sensing system may include accepting, as input, a LiDAR point cloud generated by the LiDAR sensing system, the LiDAR point cloud including points corresponding to respective received portions of light emitted by the LiDAR sensing system and reflected by an environment external to the vehicle. The method may also include identifying a set of points of the LiDAR point cloud that are within a three-dimensional region of the environment, generating a voxel direction feature using a respective position value of each point within a first collection of the set of points, generating one or more voxel intensity features using a respective intensity value of each point within a second collection of the set of points, performing a downsampling operation to obtain a third collection of points of the set of points, and generating an augmented LiDAR voxel corresponding to the three-dimensional region of the environment. In some embodiments, the augmented LiDAR voxel may include the voxel direction feature, the one or more voxel intensity features, and the third collection of points. The method may also include identifying, using the augmented LiDAR voxel, a characteristic of the environment, and adjusting an operation of at least one of a propulsion system, a steering system, or a braking system of the vehicle in response to identifying the characteristic of the environment.

In some embodiments, the vehicle may be traveling on a predetermined path within the environment, and the characteristic of the environment may be at least one of a path surface condition associated with reduced traction and positioned along a portion of the predicted path, or an object external to the vehicle and intersecting the predicted path.

In some embodiments, adjusting an operation of at least one of the propulsion system, the steering system, or the braking system may include generating, at a user interface subsystem of the vehicle, a notification indicating a change in the predicted path. The three-dimensional region may be defined by a boundary defining a rectangular prism; and the augmented LiDAR voxel is a column voxel defined by the boundary. In some embodiments, the column voxel may positioned in a first voxel layer of a voxel lattice comprising a set of voxel layers, the first voxel layer defining a height of the boundary. Identifying the characteristic of the environment may include using one or more additional augmented LiDAR voxels corresponding to one or more additional layers of the voxel lattice.

### BRIEF DESCRIPTION OF THE DRAWINGS

To easily identify the discussion of any particular element or act, the most significant digit or digits in a reference number refer to the figure number in which that element is first introduced.

FIG. 1A depicts a portion of an example roadway of a transportation system.

FIG. 1B depicts a schematic representation of an example transportation system in which a central control system may be instantiated.

FIG. 2 depicts an example vehicle.

FIG. 3A depicts an example LiDAR point cloud.

FIG. 3B depicts an example voxelization of a LiDAR point cloud.

FIG. 3C depicts an example voxelization of a LiDAR point cloud.

FIG. 3D depicts an example of aggregate feature generation for a voxel.

FIG. 3E depicts an example downsampling operation for a voxel.

FIG. 4 depicts an example system schematic for controlling an example vehicle.

FIG. 5 depicts a schematic representation of an example vehicle.

FIG. 6 illustrates an electrical block diagram of an electronic device that may perform the operations described herein.

### DETAILED DESCRIPTION

Reference will now be made in detail to representative embodiments illustrated in the accompanying drawings. It should be understood that the following description is not intended to limit the embodiments to one preferred embodiment. To the contrary, it is intended to cover alternatives, modifications, and equivalents as can be included within the spirit and scope of the described embodiments as defined by the appended claims.

The embodiments herein are generally directed to autonomous transportation systems. For example, an autonomous transportation system or service may include one or more vehicles that operate in a roadway system to pick up and drop off passengers or other cargo. An autonomous transportation system may include one or more autonomously-operated vehicles which may be integrated with roadways that include non-autonomous vehicles. As used herein, the term “roadway” may refer to a structure that supports moving vehicles, which may include autonomous vehicles, or both autonomous and non-autonomous vehicles.

Autonomous transportation systems (e.g., autonomous vehicles and/or autonomy support infrastructure, such as roadway monitoring systems that communicate with autonomous vehicles), may incorporate a variety of sensing systems to detect and identify obstacles, environmental conditions, and other like characteristics that may inform the operation of the autonomous transportation system, such as to allow the vehicles to identify or receive identifications of environmental conditions and take actions based thereon (e.g., to avoid an obstacle, decelerate for a slippery road, or the like). As described herein, sensing systems may include light detection and ranging (LiDAR) systems that are configured to emit light into an environment and image reflected portions of the emitted light. More specifically, the time of flight of an emitted light beam (indicative of distance) and the intensity of the received light (indicative of reflectivity) may each be separately measured using a LiDAR sensing system as described herein. Accordingly, the imaged light may be used to generate three-dimensional LiDAR point clouds that are indicative of the surfaces and geometries within an imaged region of the environment.

As LiDAR sensing systems are capable of producing direct measurements of distance to (and reflectance of) various points in the environment in a variety of conditions (e.g., at night), LiDAR systems may be used to ensure the safe, efficient, and effective operation of the autonomous transportation system within different driving scenarios. For instance, a LiDAR sensing system may be used to evaluate road conditions, identify and monitor objects in the environment, and/or identify edge-case scenarios, such as roadway flooding or sudden traffic stoppage.

As described herein, collections of points within LiDAR point clouds may be processed into (or otherwise used to generate) voxels corresponding to three-dimensional regions of an imaged environment. As used herein, the conversion of a LiDAR point cloud into one or more voxels is referred to as “voxelization.” Because voxels provide a three-dimensional coordinate space for indexing and storing information (e.g., sets of LiDAR points), voxelizing LiDAR point clouds may improve the efficiency and scalability of LiDAR point cloud analysis, evaluation, and/or processing.

Due to the high density of points that may exist within a LiDAR point cloud, even a single voxel may comprise enough LiDAR points to make real-time processing infeasible. For example, the time required to process all LiDAR points within a voxel to detect an obstacle and formulate avoidance instructions for avoiding the obstacle may require more time than is available before a potential collision with the obstacle becomes unavoidable. Accordingly, the number of LiDAR points within a voxel may be reduced (e.g., by discarding a number of LiDAR points) to improve processing efficiency.

However, by reducing the quantity of LiDAR points within a voxel (hereinafter referred to as “downsampling” a voxel), critical information contained within (or indicated by) the discarded LiDAR points may be lost. As one particular example, by downsampling a set of LiDAR points corresponding to an object with a protruding feature such that only a fraction of the LiDAR points remain, LiDAR points corresponding to the protruding feature may be discarded. This may result, for instance, in an over-estimation of time and distance before a collision with the object occurs.

Described herein are techniques and systems for generating augmented voxels comprising aggregate features generated using all (or a statistically significant sample of) of the points within a voxel. Aggregate features may include a principal direction feature and an intensity feature. A principal direction feature may indicate a spatial distribution of points within a voxel (e.g., a cumulative slope of an imaged surface). An intensity feature may indicate the distribution of intensity of points within a voxel (e.g., a cumulative reflectivity of an imaged surface).

A principal direction feature may represent or characterize aspects of the surface(s) (or objects more generally) defined by the position of LiDAR points within a voxel. A principal direction feature may indicate a plane of best fit or average overall slope of all (or a statistically significant subset of) the points within a voxel, and in some embodiments may indicate a statistical variance or deviation therefrom. An intensity feature may represent or characterize aspects of the reflectances of surfaces in the environment, and may be defined by or generated from the intensities of LiDAR points within a voxel. An intensity feature may indicate a distribution of intensities of all (or a statistically significant subset of) the points within the voxel, and in some embodiments may indicate a statistical variance or deviation therefrom. In some instances, a principal direction feature and/or an intensity feature may include a representation of how points within a particular voxel have varied over time.

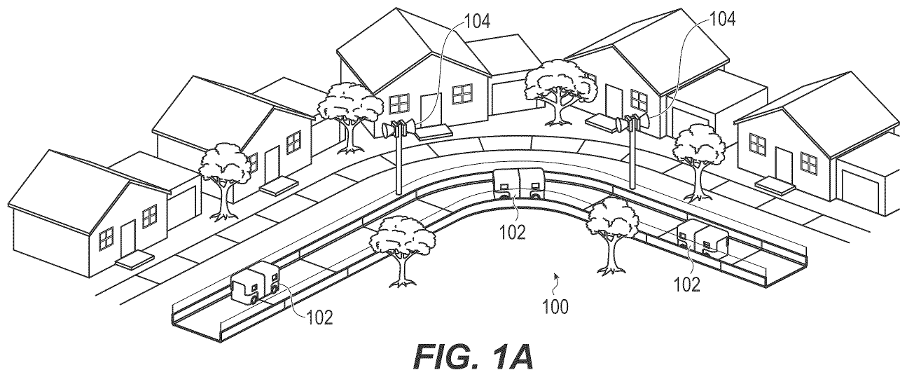

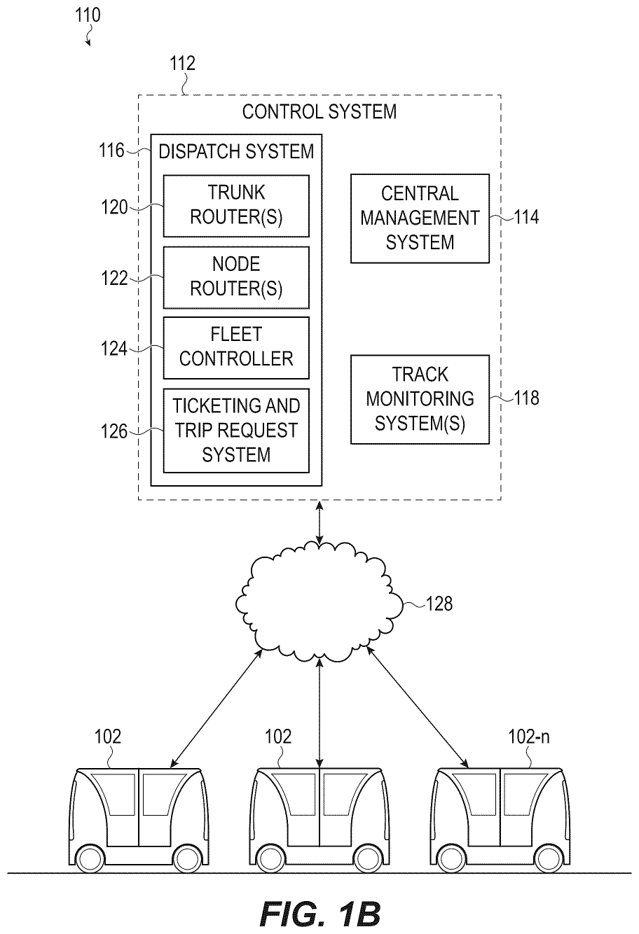

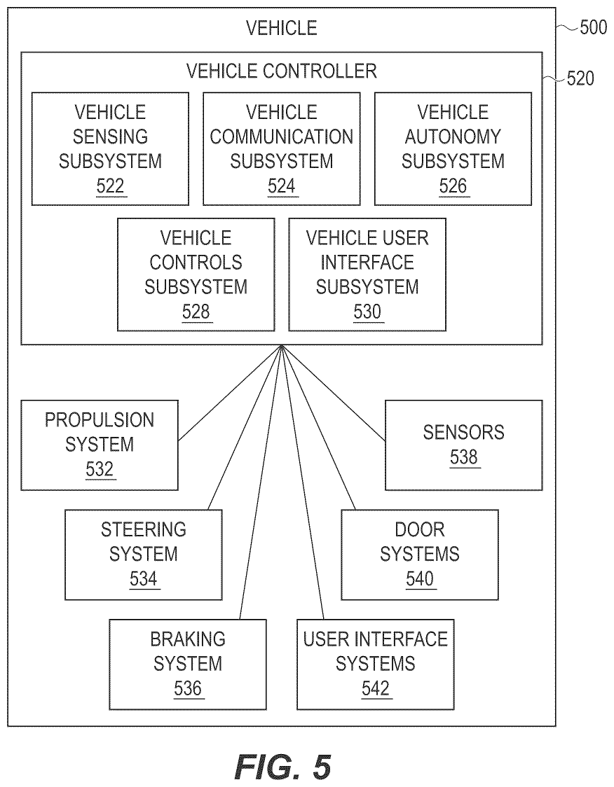

FIG. 1A illustrates a segment of a roadway system 100 for autonomous vehicles 102, in accordance with embodiments described herein. The roadway system 100 that is shown in FIG. 1A is shown at ground level, in a typical urban or suburban environment, though this is not meant to be limiting. The roadway system (or simply roadway) may be deployed in any environment or location, including rural locations, entirely or partially inside buildings, away from roadways, on elevated structures, underground, or the like. The roadway system 100 is shown with a plurality of four-wheeled autonomous vehicles 102 navigating along the roadway system 100. The autonomous vehicles 102 may be autonomous or semi-autonomous vehicles specifically designed for use with the roadway system 100 and/or conventional roadways. One example type of vehicle for use with the roadway system 100 is described with respect to FIG. 5, though other types of vehicles may be driven along the roadway system 100 instead of or in addition to those described herein. The roadway system 100, of which the segment shown in FIG. 1A may only be a small portion, may include multiple segments including straightaways, turns, bridges, tunnels, ramps, and the like. As used herein, a roadway system may describe the set of physical structures of a transportation system where vehicles may operate, and may include trunk lanes, boarding zones, parking facilities (e.g., parking lots, parking garages), maintenance facilities, intersections, merging zones, and the like.

The roadway system 100 may also include one or more roadway sensor modules 104. A roadway sensor module 104 may be configured to communicate directly with the autonomous vehicles 102, a control system 101, and/or other controllers, modules, systems, or other components (physical or functional) of the roadway system 100. The roadway sensor module 104 may include a LiDAR sensing system, such as those described herein, as well as additional processing systems, sensing systems, communication systems, and other like components for facilitating sensing and/or monitoring operations.

FIG. 1B depicts an example transportation system 110 that may use the techniques and include the systems and infrastructure described herein. The transportation system 110 includes a transportation system control system 112 that can communicate with autonomous vehicles 102 (e.g., vehicles 102-1, . . . , 102-n) of the transportation system 110 (as well as numerous other systems, components, sensors, etc.), to facilitate the operations of the transportation system 110, including physical and virtual and/or simulated operations. The control system 112 may include a central management system (CMS) 114, a dispatch system 116, and one or more track monitoring systems (TMS) 118. In other examples, the transportation control system 112 may include or be implemented by different systems or combinations of systems.

The transportation control system 112 may include a dispatch system 116. The dispatch system 116 may determine the trajectories for vehicles and may generally control how the vehicles travel throughout the transportation system. The dispatch system 116 may include trunk router(s) 120, node router(s) 122, fleet controller 124, and ticketing and trip request system 126.

The one or more trunk routers 120 generally manage vehicle allocations along associated trunk lanes. In some examples, each trunk lane of a transportation system may have an associated trunk router 120.

Trunk routers may manage vehicle allocations along associated trunk lanes. For example, a trunk router may define or otherwise manage spacetime trajectories for vehicles along its associated trunk lane(s), and may communicate spacetime trajectories (e.g., paths) to vehicles. For example, in response to a request from a node router 122 (associated with a boarding zone or other location associated with the node router and from which a vehicle is departing and attempting to join the trunk lane), a trunk router 120 may generate and/or assign a spacetime trajectory to a vehicle that is departing from the boarding zone (or other location), and convey the specification of the spacetime trajectory to the node router 122 (which may then convey the spacetime trajectory to the vehicle). Spacetime trajectories may correspond to, define, or otherwise cause a vehicle to travel along a predetermined path along the roadways of a transportation system (e.g., a predetermined path following a route from an origin location to a destination location). The trunk routers 120 may maintain a record of all spacetime trajectories and the vehicles to which spacetime trajectories have been assigned. The trunk routers 120 may generate spacetime trajectories or perform other operations associated with the trunk routers 120 for vehicles, as described herein. Spacetime trajectories may be fully deconflicted with respect to each other, such that no assigned spacetime trajectories result in vehicles occupying the same space at the same time.

The one or more node routers 122 generally manage vehicle departures and arrivals at associated nodes in the transportation system (e.g., boarding zones, intersections, transition zones between roadways, parking lots, and the like). For example, a node router 122 may manage vehicle departures and arrivals at a boarding zone (e.g., via trunk lanes). As used herein, nodes may generally refer to locations, areas, or regions in the transportation system that are connected to and/or accessible by trunk lanes. Nodes may act as origin, destination, or intermediate locations of a path. As described herein, each trip may begin and end at a node (e.g., an origin and a destination boarding zone, respectively), and may pass through zero or more intermediate nodes when performing a trip. Moreover, each segment of a vehicle's journey may begin and end at a node. For example, as described herein, a first segment of a vehicle trajectory may extend from a first node (origin boarding zone), along a trunk lane, to a second node (e.g., an intersection). In some examples, each node of a transportation system may have an associated node router 122.

Where a node router 122 acts as a boarding zone router, the node router may manage vehicle departures and arrivals at an associated boarding zone. In such cases, the node router 122 may determine when vehicles can depart from parking spots in order to begin a trip, and when vehicles can enter parking spots in order to conclude a trip. A node router 122 may perform trajectory deconfliction within an associated boarding zone, and may use the results of the trajectory deconfliction to determine when vehicles can travel through the boarding zone. For example, a node router 122 may compare a proposed trajectory segment of a vehicle that is waiting to depart to other known trajectories through the boarding zone, and may instruct the vehicle to depart once it determines that its proposed trajectory segment is deconflicted. Node routers 122 may also request spacetime trajectories from trunk routers that manage trunk lanes that are connected to the boarding zone (and on which a vehicle is assigned to travel). The node routers 122 may then determine a vehicle departure time, trajectory, and/or other vehicle operational parameters for a departing vehicle based on the particular spacetime trajectory that is assigned to (e.g., reserved for) that vehicle. Node routers 122 may perform the same or similar operations when they are associated with other types of nodes in the transportation system, such as intersections. For example, the node routers 122 may perform trajectory deconfliction within contested zones managed by the node routers, and may use the results of the trajectory deconfliction to determine when vehicles can travel through the contested zones. Node routers 122 may also request spacetime trajectories from trunk routers that manage the trunk lanes that are connected to the node. The node routers may then determine a vehicle departure time, trajectory, and/or other vehicle operational parameter for a departing vehicle based on the particular spacetime trajectory that is assigned to (e.g., reserved for) that vehicle. The node routers may ultimately provide, to a vehicle, information that will cause the vehicle to travel to another node (controlled by another node router). For example, a node router for a first node may provide a trajectory extending from the first node to a next node along the vehicle's route (e.g., a next boarding zone, a next intersection, or the like). As described herein, an entire trajectory for a vehicle (e.g., to cause the vehicle to traverse a predetermined path) may be provided by one or more node routers (e.g., boarding zone routers, intersection routers, etc.).

The fleet controller 124 may maintain a registry of each vehicle operating in its associated transportation system (e.g., the vehicle fleet for that transportation system), as well as information about each vehicle. Example vehicle information may include, without limitation, vehicle location, current occupant, next scheduled location, assigned/current spacetime trajectories, vehicle maintenance records, and the like.

The dispatch system 116 may further include a ticketing and trip request (TTR) system 126. The TTR system 126 generates tickets in response to trip requests from passengers in the transportation system. For example, the TTR system 126 may receive a trip request from a passenger. Trip requests may be sent to the TTR system 126 (or to the control system 101 more generally) via smartphones, kiosks (e.g., at boarding zones or other locations), computers, conventional telephones, wearable devices, or any other suitable device and/or communication technique.

Trip requests, and/or tickets generated by the TTR system 126 for trip requests, may include information such as the identity of the requestor, an origin location (e.g., a boarding zone or other location where the requestor is to be picked up), a destination location (e.g., a boarding zone or other location where the requestor is to be dropped off), and, optionally, a requested trip start time (e.g., a time at which the vehicle should arrive at the origin location) or trip end time (e.g., a time at which the vehicle should arrive at the destination location).

The TTR system 126 may select a vehicle for the trip request and assign the trip request to the vehicle. In some examples the TTR system 126 may match the trip request to available or potentially available vehicles in light of other trip requests.

The various systems, components, computers, servers, sensors, etc., of the transportation system 112 may communicate via one or more communication systems and/or networks 128. While the transportation control system 112 is shown as having certain discrete subsystems, these subsystems may be combined in some example transportation systems. More particularly, functions and/or operations that are described herein as being performed or otherwise associated with the CMS 114, the dispatch system 116, and the TMS 118 may be performed by a single integrated system, or may be split into further subsystems or in some cases distributed across the autonomous vehicles 102. Moreover, additional systems, subsystems, modules, controllers, and the like may be included in the transportation control system 112. As an example, the TMS 118 communicate with (or may include) discrete roadway sensor modules 104 described with respect to FIG. 1A. More generally, a particular association between a function or operation and a portion or subsystem of the transportation control system 112 relates to an example implementation, and in other example implementations, different functions and/or operations are associated with and/or performed by other portions or subsystems.

In some foregoing examples, the transportation system 112 generates and assigns spacetime trajectories to vehicles to cause the vehicles to traverse a particular predetermined path or route. Spacetime trajectories may be defined or represented in various ways. For example, a spacetime trajectory may be defined by a parametric representation that defines position, velocity, and acceleration as a function of time. A vehicle may use the parametric representation to travel along the roadway system according to the prescribed spacetime trajectory. As described herein, spacetime trajectories may be generated such that at least a portion of the trajectory coincides with a predefined moving position-target (e.g., a vehicle following a particular spacetime trajectory along a trunk lane will be following a selected moving position-target). Spacetime trajectories may also be generated without reference to predefined moving position-targets.

In order to execute a trip request, or otherwise traverse a route in the transportation system, a vehicle may be provided with a spacetime trajectory (e.g., a parametric representation or other data structure that defines a position, velocity, and acceleration of the vehicle with respect to time). To traverse or follow a spacetime trajectory, the vehicles independently attempt to maintain the position, velocity, and acceleration values defined by the function. Thus, for example, a vehicle may follow a spacetime trajectory by using the particular parametric representation (or other function defining position, velocity, and acceleration with respect to time) that is provided to and/or generated by the vehicle.

As described herein, in addition to a vehicle operating its various systems (e.g., propulsion, braking, steering) in order to follow a spacetime trajectory, the vehicles may also implement various local autonomy schemes that allow it to respond to its environment in real time and ensure safe operations. For example, the vehicles may include various sensing systems that allow the vehicles to detect and identify characteristics of their environment, such as obstacles therein, weather conditions, road conditions, and so forth. The vehicles may be configured to respond to the sensed information, such as to avoid potential hazards or obstacles, respond to unexpected braking events from nearby vehicles, change vehicle operations in response to certain roadway conditions (e.g., wet or icy pavement), or the like. Thus, while the transportation system may fully define the spacetime trajectories for vehicles, the vehicles have a local autonomy system, including various sensor systems, that allows them to monitor and respond to the environment in real-time (even if that results in deviation from an assigned spacetime trajectory).

While the foregoing discussion describes the vehicles of the transportation system being provided with spacetime trajectories, this is just one example technique for controlling vehicles and vehicle motion in a transportation system. As another example, vehicles may be provided with a destination, and the vehicles themselves determine a travel path based on map data, real-time environmental data (e.g., from one or more sensing systems), reported locations and/or trajectories of other vehicles (received from the other vehicles or from a central resource, such as the dispatch system 116, the central management system 114, and/or the track monitoring system(s) 118), and the like. In some cases, routes may be provided to a vehicle, and the vehicle autonomously traverses the route based on real-time environmental data. In such cases, the routes may lack time-based constraints or specifications, such that the vehicle traverses the route according to local and/or real-time conditions. Other vehicle control schemes are also contemplated, and the techniques described herein, such as with respect to analyzing LiDAR sensor data, may be used in transportation systems and/or by vehicles employing any suitable or compatible vehicle control schemes.

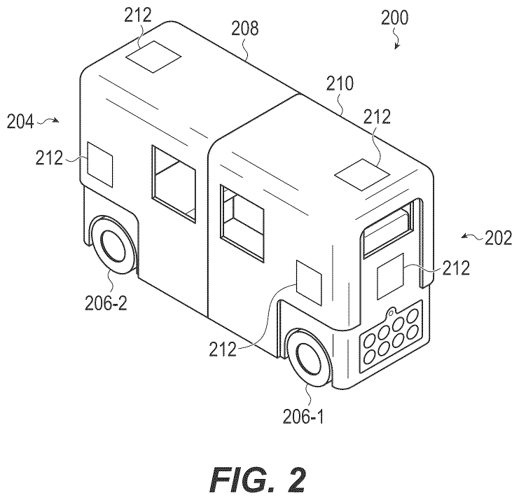

FIG. 2 is a perspective view of an example autonomous vehicle 200. The vehicle 200 may correspond to or be an embodiment of the vehicles 102, or any other vehicle described herein. As shown, the vehicle 200 defines a first end 202, shown in the forefront in FIG. 2, and a second end 204. In some examples and as shown, the first end 202 and the second end 204 are substantially identical, such that bidirectional operation may be improved. The vehicle 200 may be configured so that it can be driven with either end facing the direction of travel (e.g., for improved bidirectional operation).

The vehicle 200 may also include wheels 206 (e.g., wheels 206-1-206-4). The wheels 206 may be paired according to their proximity to an end of the vehicle. Thus, wheels 206-1, 206-3 may be positioned proximate the first end 202 of the vehicle and may be referred to as a first pair of wheels 206, and the wheels 206-2, 206-4 may be positioned proximate the second end 204 of the vehicle and may be referred to as a second pair of wheels 206. Each pair of wheels may be driven by one or more motors (e.g., an electric motor). In some embodiments, each pair of wheels is capable of turning to steer the vehicle, such that the vehicle may have similar driving and handling characteristics regardless of the direction of travel. In some cases, the vehicle may be operated in a two-wheel steering mode, in which only one pair of wheels steers the vehicle 200 at a given time. In such cases, the particular pair of wheels that steers the vehicle 200 may change when the direction of travel changes. In other cases, the vehicle may be operated in a four-wheel steering mode, in which the wheels are operated in concert to steer the vehicle. In a four-wheel steering mode, the pairs of wheels may either turn in the same direction or in opposite directions, depending on the steering maneuver being performed and/or the speed of the vehicle.

The vehicle 200 may also include doors 208, 210 that open to allow passengers and other cargo (e.g., packages, luggage, freight) to be placed inside the vehicle 200. The doors 208, 210 may extend over the top of the vehicle such that they each define two opposite side segments. For example, each door defines a side segment on a first side of the vehicle and another side segment on a second, opposite side of the vehicle.

The vehicle 200 may also include a vehicle controller 520 (FIG. 5) that controls the operations of the vehicle 200 and the vehicle's systems and/or subsystems, including LiDAR sensing systems (e.g., LiDAR emitters and receivers), communications systems, ingress and egress systems, and the like. For example, the vehicle controller may control the vehicle's propulsion system, steering system, suspension system, braking system, doors, lights, sensing systems, onboard LiDAR emitters and receivers, wireless communications, and the like, to facilitate vehicle operation, including navigating the vehicle 200 along a roadway (e.g., roadway system 100 of FIG. 1) in accordance with one or more vehicle control schemes. The vehicle controller may also be configured to communicate with other vehicles, the transportation control system (e.g., the CMS 114, the dispatch system 116, TMS 118, etc. of FIG. 1B), roadway sensor modules (e.g., the roadway sensor module 104), and/or other components of the transportation system. For example, the vehicle controller may be configured to receive information from external systems. For example, the vehicle controller may receive information such as the speed and location of other autonomous vehicles, remote LiDAR data generated by other vehicles and roadway systems (e.g., sensor modules 104 of FIG. 1), and the like. The vehicle controller may include computers, processors, memory, circuitry, or any other suitable hardware components, and may be interconnected with other systems of the vehicle to facilitate the operations described herein, as well as other vehicle operations.

The vehicle 200 may be configured to navigate in accordance with one or more vehicle control schemes. The vehicle control schemes may include predefined routes, autonomous fleet coordination, contingency behaviors, and other like control schemes. In some cases, the vehicle control instructions (e.g., spacetime trajectories, routes, destinations, etc.) may be provided by a remote control system (e.g., control system 101 of FIG. 1), received from other autonomous vehicles, generated by the vehicle 200 directly, and/or a combination thereof. In some cases, the vehicle 200 may use various sensor data (e.g., LiDAR data) to detect and identify characteristics of the environment, such as obstacles therein. As used herein, identifying objects, characteristics of an environment, road conditions, etc., may refer to detecting the presence of such objects, characteristics of an environment, the presence and/or properties of road conditions, etc., and/or labeling or otherwise associating an identity to such objects, characteristics of an environment, road conditions, etc.

The vehicle 200 may be configured to deviate from a trajectory (e.g., a predetermined spacetime trajectory, a self-generated trajectory, etc.) in response to traffic and road conditions, potential hazards, and other like intervening characteristics of the environment. In some cases, the vehicle 200 may use various sensor data to determine routes or predict paths of travel in order to perform transportation tasks. For example, in an example implementation, a vehicle is provided with a destination and the vehicle itself determines its travel path based on map data and real-time environmental data, such as from a LiDAR system.

The vehicle 200 may also include a LiDAR sensing system including one or more LIDAR modules 212. A LIDAR module 212 may be oriented to face a particular direction such that it may image a particular region of the environment relative to the autonomous vehicle 200. In some instances, a LiDAR module 212 (and/or a combination of LiDAR modules) may be configured to image substantially all of an environment surrounding the vehicle 200 (e.g., as a rotary or 360 degree LiDAR module). Additionally or alternatively, one or more LiDAR modules 212 may be positioned at specific locations on the vehicle (e.g., on the first end 202 and the second end 204, the top, one or more corners, etc.). The LiDAR modules 212 may each separately generate a respective LiDAR point cloud, or one or more of the LiDAR sensing systems 212 may cooperate to produce one or more common LiDAR point clouds. In some embodiments, the LiDAR modules 212 may be configured to gimbal, aim, or reorient such that different regions of the environment may be imaged.

As used herein, a LiDAR module 212 may include a LiDAR emitter that operates to emit light (e.g., as an array of discrete light beams) into an environment. When the emitted light is reflected by the environment, the light may be received by a LiDAR sensor of the LiDAR module 212 and imaged. When the light is imaged, the time-of-flight of the light may be used to determine a distance to a point in the environment from which the emitted light was reflected. Further, the intensity of the received light may be used to determine a reflectance of the point in the environment that reflected the light (e.g., as less reflective surfaces will return a lower intensity reflection of light to the LiDAR module 212). In some cases, a LiDAR point (or LiDAR point cloud) may be constructed using one or more data structures, such as a positional data structure and an intensity data structure, or a combination of both. As described herein, LIDAR modules such as the module 212 in FIG. 2, may be deployed in various locations and contexts within a transportation system, including on other vehicles, other types of vehicles (e.g., dedicated roadway or environmental monitoring vehicles, construction vehicles, etc.), stationary installations (e.g., roadway sensor modules 104), at boarding zones, at parking and/or maintenance facilities, and the like.

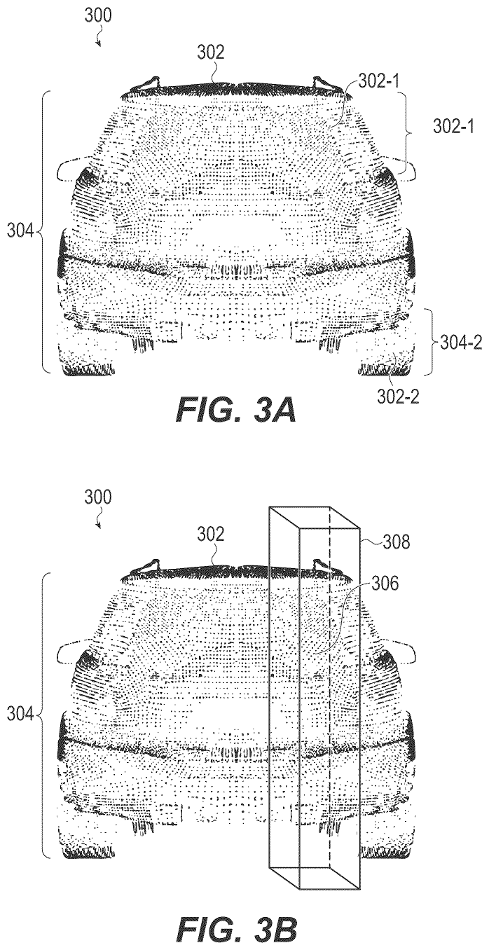

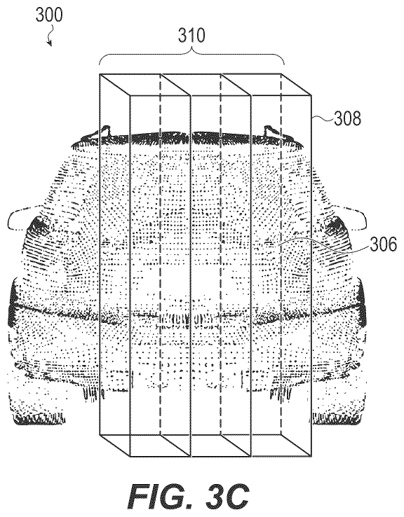

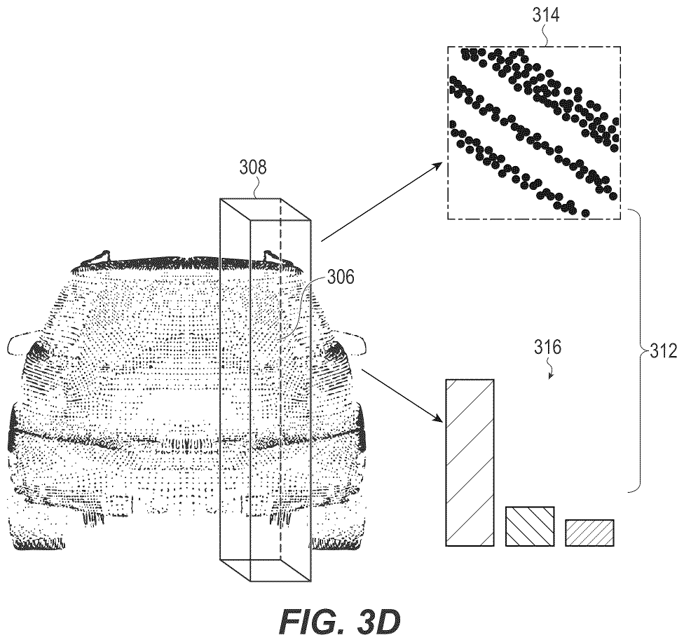

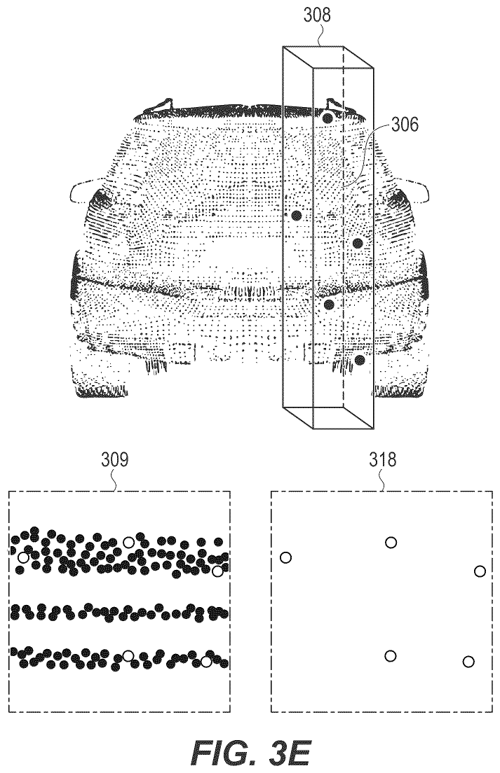

FIGS. 3A-3E depict representations of example operations for processing a LiDAR point cloud 300. The LiDAR point cloud 300 may be generated by a LiDAR sensing system as described herein (e.g., a LiDAR sensing system on an autonomous vehicle or otherwise deployed in a transportation system). As described, a LiDAR sensing system may include a LiDAR emitter and a LiDAR receiver or sensor (e.g., of a LiDAR module), as well as associated circuitry, processing systems, memory, and the like.

FIG. 3A depicts the LiDAR point cloud 300 obtained from a LiDAR sensing system (e.g., using one or more LiDAR modules 212) that has imaged a rear portion of a vehicle 302. The rear portion of the vehicle is provided as an illustrative example, but it will be understood that a LiDAR point cloud may correspond to any environment (and may include any number of different objects, surfaces, people, obstacles, etc.). A LiDAR point cloud may include points corresponding to respective portions of light that are emitted by the LiDAR sensing system, reflected by objects, and received by the LiDAR system, as described with respect to FIG. 2.

As shown, each LiDAR point 304 may represent (e.g., be associated with and/or defined by a value corresponding to) a particular location (e.g., a position value) in a three-dimensional space from which light emitted by a LiDAR system (e.g., from a LiDAR module 212) was reflected. Further, each LiDAR point 304 may represent (e.g., be associated with and/or defined by a value corresponding to) an intensity (e.g., an intensity value) of the reflected light. Accordingly, each LiDAR point 304 may represent a location in the environment from which light was reflected (e.g., a point on a surface) and a reflectance of the environment at that location (e.g., a reflectance of the surface, or surface reflectance). Each LiDAR point 304 may be defined by (and/or stored as) a set of one or more parameters representing the location and the intensity. When viewed together or in aggregate, the LiDAR points 304 may represent a three-dimensional mapping of surfaces within an environment.

As an example, LiDAR points 304-1 may be associated with a subregion 302-1 of the vehicle, and LiDAR points 304-2 may be associated with a subregion 302-2 of the vehicle. As shown, the subregion 302-1 of the vehicle may be a rear window, and the subregion 302-2 of the vehicle may be a rear tire of the vehicle 302. In this example, the LiDAR points 304-1 may have higher intensity values than the LiDAR points 304-2 and be distributed more flatly than the LiDAR points 304-2 (e.g., due to the high reflectance and planarity of a tinted glass window relative to a round tire), in addition to having distinct positions within three-dimensional space.

It should be appreciated that the LiDAR point cloud 300 is merely an illustrative example. A LIDAR point cloud as described herein may incorporate a greater or lesser quantity of points, include points corresponding to different or additional aspects of an environment (e.g., dry, wet, or icy road surfaces, debris, pedestrians, etc.). Further, a LiDAR point cloud as described herein may include LiDAR point clouds generated using randomly, stochastically, or otherwise non-uniformly emitted light, and therefore include irregular distributions of LiDAR points.

FIG. 3B depicts an example partial voxelization of the LiDAR point cloud 300. As used herein, “voxelization” refers to the process of partitioning a three-dimensional space (and the LiDAR points therein) into a discretized volumetric structure such as a volumetric grid, voxel lattice, or other like organization. The voxelization of a LiDAR point cloud 300 may reduce the computational complexity associated with a subsequent processing of the LiDAR point cloud 300 by providing a regularized data structure.

As used herein, the term “voxel” may refer to a discrete unit of a discretized volumetric structure (e.g., a bounded volume), and/or to a data structure or other information that is used to define, represent, or characterize a discrete unit of a discretized volumetric structure and/or its contents (including real-world contents of the discrete unit of the volumetric structure and/or LiDAR points that are in the discrete unit of the volumetric structure).

In some instances, a voxelization engine may be used to associate points of a LiDAR point cloud with respective voxels (e.g., points positioned within the three-dimensional region defined by the respective voxels). The voxelization engine may be a software or program instantiated at least in part by one or more processor components of a vehicle or transportation control system (e.g., vehicle 200 and/or transportation control system 112).

As used herein, LiDAR points within a voxel may be referred to as “occupying” the voxel, and assessments of points within a voxel (including, in some cases, determinations that there are no points within a voxel) may be referred to as assessments about its occupancy. Each voxel may have a respective coordinate or index, and be associated with (or directly store) additional information derived from or indicated by the LiDAR points therein. In some cases, a voxelization engine may be used to downsample the points occupying respective voxels, as described herein.

As shown in FIG. 3B, a subset of points 306 of the LiDAR point cloud 300 have been partitioned into a voxel 308. Each point 306 occupies (e.g., is positioned in) a three-dimensional region of the environment that is bounded or defined by the voxel 308. The three-dimensional region of the environment (e.g., the three-dimensional shape defined by the voxel) may be defined by a boundary, such as a cube, rectangular prism, or other like tessellating geometry. As shown, the voxel 308 is bounded or defined by a rectangular prism having a square base and a height greater than the sides of its base. As used herein, a voxel configured as voxel 308 may be referred to as a “column” or “pillar” voxel.

In some instances, a LiDAR point cloud may be voxelized into voxels having varying dimensions. As an example, a first layer (e.g., a first voxel layer) of a voxel grid may have a first layer height, and a second layer (e.g., a second voxel layer) of a voxel grid may have a second layer height that is different from the first layer height. In this example, the first layer height may be associated with a height of an autonomous vehicle (e.g., vehicle 200), but it should be appreciated that any layer height (or combination thereof) may be used. In some instances, the voxelization engine may be configured to update or modify the voxelization process (e.g., to alter the dimensions and/or resolution of voxels), such as in response to denser traffic conditions, weather conditions, road conditions, etc.

As shown in FIG. 3C, an array of multiple voxels 310 may be constructed, such as described with respect to FIG. 3B. It should be appreciated that the array of voxels 310 is merely illustrative, and that the voxels 310 may include additional voxels extending in any direction (e.g., in additional vertical layers). Accordingly, the array of voxels 310 may represent additional and/or larger regions of an environment, and may represent multiple objects and/or characteristics of the environment.

FIG. 3D shows an example generation of aggregate features 312 using the LiDAR points 306 within the voxel 308. As mentioned, because downsampling the points occupying a voxel (as described with respect to FIG. 3E) may result in information contained within (or indicated by) the discarded LiDAR points being lost, aggregate features 312 generated from all of the LiDAR points 306 (or a statistically significant portion thereof) may preserve useful information.

Aggregate features 312 may include a principal direction feature 314 (or multiple thereof) and an intensity feature 316 (or multiple thereof). The principal direction feature 314 (e.g., a voxel direction feature) may represent a spatial distribution of points 306 within the voxel 308, and the intensity feature 316 (e.g., a voxel intensity feature) may represent a distribution of intensities of points 306 within the voxel 308.

As mentioned, the principal direction feature 314 is generated using all (or a statistically significant portion of) the LiDAR points 306. Accordingly, the principal direction may indicate, represent, and/or be used to determine various aspects of a surface's geometry and/or topology. For instance, the principal direction feature 314 may indicate an aggregate convexity or concavity of surface geometries within a voxel. In some cases, the principal direction feature 314 may be generated by calculating a centroid of the LiDAR points 306 from a birds-eye view and performing a principal component analysis centered at the calculated centroid, as described herein. Performing a principal component analysis in a bird's-eye view as described may yield a closed-form solution in a manner that is efficiently parallelizable and operable in linear time. It should be appreciated that the operations discussed with respect to the LiDAR points 306, these operations may be performed on LiDAR points within multiple and/or different voxels (e.g., these operations may be performed for any voxel having occupying LiDAR points).

The principal direction feature 314 may be generated in a variety of manners, such as by using a median or average of all (or a statistically significant portion of) relative slopes between each adjacent point pairing, a plane of best fit for the LiDAR points 306, or any other like operation. Accordingly, the principal direction feature 314 may indicate other or additional aspects of surface geometries and/or topologies. Generally and broadly, the principle direction feature (also referred to as a voxel direction feature) may be generated using respective position values of all (or a statistically significant portion of) the LiDAR points in a voxel.

The intensity feature 316 may indicate, represent, and/or be used to determine distributions, averages, and/or deviations of the intensities of the LiDAR points 306. For example, the intensity feature 316 may include a summary statistic representing the mean and standard deviation of the intensities of the LiDAR points 306. Alternatively or in addition, the intensity feature 316 may include a distribution statistic representing the overall distribution of the intensities of the LiDAR points 306. More broadly, the intensity feature 316 may include multiple voxel intensity features, such as an intensity distribution feature and an intensity deviation feature. Generally and broadly, the intensity feature (also referred to as a voxel intensity feature) may be generated using respective intensity values of all (or a statistically significant portion of) the LiDAR points in a voxel.

FIG. 3E shows an example voxel downsampling operation. In some cases, a subset of the LiDAR points within a voxel (e.g., a subset of the LiDAR points 306 within voxel 308) may be discarded to improve the computational efficiency of processing voxel data. As shown, a downsampled collection of LiDAR points 318 is obtained from the LiDAR points 306 (shown in birds-eye view 309 of the voxel 308), with the remaining LiDAR points being discarded.

In some instances, the downsampled collection of LiDAR points 318 may be obtained using a random downsampling operation, such as a stochastic discard operation. It should be appreciated that the downsampled collection of LiDAR points 318 may be obtained in a variety of manners, such as by using the principal direction feature 314 or the intensity feature 316 to identify a collection of points that are salient or otherwise representative of the LiDAR points that may be discarded. Accordingly, the aggregate features for a voxel are generated using a greater number of points than the collection of points obtained by downsampling the points within a voxel. In this way, aggregate information derived from the greater number of points may be preserved and utilized without foregoing the performance and/or computational efficiency of a downsampled voxel.

As mentioned, principal direction feature(s), intensity feature(s), and a downsampled collection of LiDAR points may be combined or associated to obtain an augmented LiDAR voxel (e.g., a data structure that includes representations of the direction feature(s), intensity feature(s), and a downsampled collection of LiDAR points for a discrete unit of a discretized volumetric structure). For example, the principal direction feature 314, the intensity feature 316, and the downsampled collection of LiDAR points 318 generated with respect to voxel 308 may be combined (or otherwise associated) to obtain an augmented LiDAR voxel (or simply augmented voxel) as described herein.

Because LiDAR points within voxels (e.g., the voxels 310 of FIG. 3C) may be used to generate a representation of the surfaces in the environment (e.g., via an augmented voxel including the downsampled collection of points 318, the principal direction feature 314, and/or the intensity feature 316), augmented voxels as described herein may be analyzed to identify particular objects, trajectories of objects, road or path surface conditions, and other characteristics of an environment. In some cases, multiple augmented voxels may be used to identify a characteristic in the environment. Thus, augmented voxels may be used to inform and improve the navigation and control of autonomous vehicle(s) (e.g., vehicle 200), such as by providing an efficient manner for detecting obstacles (e.g., objects external to the vehicle that may intersect a predicted or predetermined path of the vehicle), hazardous road or path surface conditions (e.g., icy or wet road conditions within a vehicle's predicted or predetermined path that may cause reduced traction), and/or any other feature of the environment that may be useful in determining or managing vehicle operations. In examples where the augmented voxels are used to process or evaluate LiDAR data from other LiDAR system installations (e.g., boarding zones, parking facilities, non-transportation related implementations, etc.), the augmented voxels may generally improve the recognition of objects, conditions, or the like, in such implementations.

It should be appreciated that the generation of aggregate features 312 and downsampling operations described herein may be applied to any discretized volumetric structure, including any grid, voxel lattice, or like arrangement of three-dimensional volumes such as the voxels described herein. More specifically, these and like operations do not require that voxels be configured as column or pillar voxels, and may be applied to any number of voxels spanning any number of layers or dimensionalities.

As mentioned, a principal direction feature f_{pd} (e.g., principal direction feature 314) may be generated in a variety of manners. In some instances, a voxel may include points having three-dimensional coordinates (e.g., x, y, z values) and intensity values (e.g., i values). Thus, given n points within a voxel having points P={(x_j, y_j, z_j, i_j)┤|j=1, 2, . . . , n}, the centroid c of the points may be computed from a bird's-eye view (e.g., two-dimensionally from the top down) as follows:

$$( {x}_{c} , {y}_{c} ) = ( \frac{1}{n} {\sum }_{j = 1}^{n} {x}_{j} , \frac{1}{n} {\sum }_{j = 1}^{n} {y}_{j} )$$

Subsequently, a principal component analysis may be performed on the 2D points centered at the centroid to obtain the centered points Q={ [symbol] (x [symbol] _j−x_c, y_j−y_c)|j=1, 2, . . . , n}. The covariance matrix C may be determined from the data matrix Q:

$$C = \frac{1}{n} {Q}^{T} Q$$

Subsequently, an eigenvalue decomposition may be performed on C to obtain the eigenvalues λᵢ and the corresponding eigenvectors vᵢ using a direct analytical solution. For the covariance matrix C:

$$C = ( \begin{matrix}{c}_{11} & {c}_{12} \\ {c}_{21} & {c}_{22}\end{matrix} )$$

By expanding the determinant of the matrix C−λI, the following quadratic equation may be solved to obtain the eigenvalues:

$${λ}^{2} - ( {c}_{11} + {c}_{22} ) λ + ( {c}_{21} {c}_{22} - {c}_{12} {c}_{21} ) = 0$$

The solutions to this equation provide the eigenvalues λ₁ and λ₂, and the corresponding eigenvectors can be obtained by substituting each eigenvalue back into the eigenvalue equation:

$$C ( \begin{matrix}{v}_{i 1} \\ {v}_{i 2}\end{matrix} ) = {λ}_{i} ( \begin{matrix}{v}_{i 1} \\ {v}_{i 2}\end{matrix} )$$

Accordingly, the eigenvectors may be scaled by the corresponding eigenvalues to obtain a principal direction feature f_{pd} (e.g., principal direction feature 314):

$${f}_{pd} = {( \sqrt{{λ}_{1}} {v}_{11} , \sqrt{{λ}_{1}} {v}_{12} , \sqrt{{λ}_{2}} {v}_{21} , \sqrt{{λ}_{2}} {v}_{22} )}^{T}$$

As mentioned, an intensity feature (e.g., intensity feature 316) may be generated in a variety of manners. In some cases, for all (or at least a subset of) points (xⱼ, yⱼ, zⱼ, iⱼ) within a voxel (e.g., voxel 308), the mean μ and standard deviation σ of the intensity values may be obtained:

$$μ = \frac{1}{n} {\sum }_{j = 1}^{n} {i}_{j}$$

Accordingly, the mean u may be obtained. The standard deviation σ follows:

$$σ = \sqrt{\frac{1}{n} {\sum }_{j = 1}^{n} {( {i}_{j} - μ )}^{2}}$$

Thus, an intensity summary statistic feature fₛₛ (e.g., intensity feature 316) may be obtained as follows:

$${f}_{ss} = {( μ , σ )}^{T}$$

As mentioned, an intensity feature 316 may incorporate a variety of information. In some cases, for all or at least a subset of points (xⱼ, yⱼ, zⱼ, iⱼ) within a voxel, a histogram of intensity distribution may be obtained by dividing the range of intensity values into K bins:

$${h}_{k} = {\sum }_{j = 1}^{n} count ( {i}_{j} ∈ {B}_{k} ) , k = 1 , 2 , … .$$

Where count is the counting function, which increments by 1 if the condition inside is true. Bₖ represents the kth bin, and hₖ is the count of intensity values falling into bin Bₖ. Accordingly, an intensity distribution statistic f_{ds} may be obtained:

$${f}_{ds} = {( {h}_{1} , {h}_{2} , … , {h}_{k} )}^{T}$$

Assuming the dynamic range of the intensity values is in [0, 1], and Bₖ=[Iₖ, Iₖ₊₁) for k=1, 2, . . . , K−1, interval values/may be uniformly selected across the dynamic range. The last bin's interval values may be set as B_{K}=[1, ∞). This choice accounts for LiDAR systems which classify any points exceeding a maximum dynamic range as 1.

In some cases, each of the intensity distribution statistic f_{ds} and the intensity summary statistic feature fₛₛ may be incorporated into a voxel intensity feature (e.g., as an intensity distribution feature and an intensity deviation feature of the intensity feature 316). For example, the distribution statistic may be or may represent a histogram of intensity values within a dynamic range calculated based on the distribution of intensities of the LiDAR points 306. In some cases, the intensity feature 316 may be generated in a variety of alternative or additional manners, such as by using an intensity interval analysis, intensity value bucketing, or any other appropriate operation.

The combined intensity features fₛₛ, f_{ds} and principal direction feature f_{pd} for an augmented voxel may therefore be represented by the following equation:

$${f}_{augmented voxel} = {( {f}_{pd} , {f}_{ss} , {f}_{ds} )}^{T}$$

In some cases, the LiDAR points occupying a voxel, the aggregate features, and any other like augmented voxel and/or LiDAR data may or may not be stored as a combined data structure. For example, in some cases, the aggregate features for a particular voxel may be associated with the particular voxel, but not directly stored within a shared data structure. In this example, the aggregate features may be stored in a feature table and mapped to particular voxels stored in a voxel data structure. As another example, the LiDAR points that occupy a particular voxel may not be stored directly within the particular voxel, but associated with the particular voxel (e.g., by an association table). In some instances, all or a portion of the augmented voxel data for a particular voxel may be stored within a shared data structure for the particular voxel. In some cases, multiple augmented voxels may share a single data structure, be distributed across multiple data structures, or a combination of both.

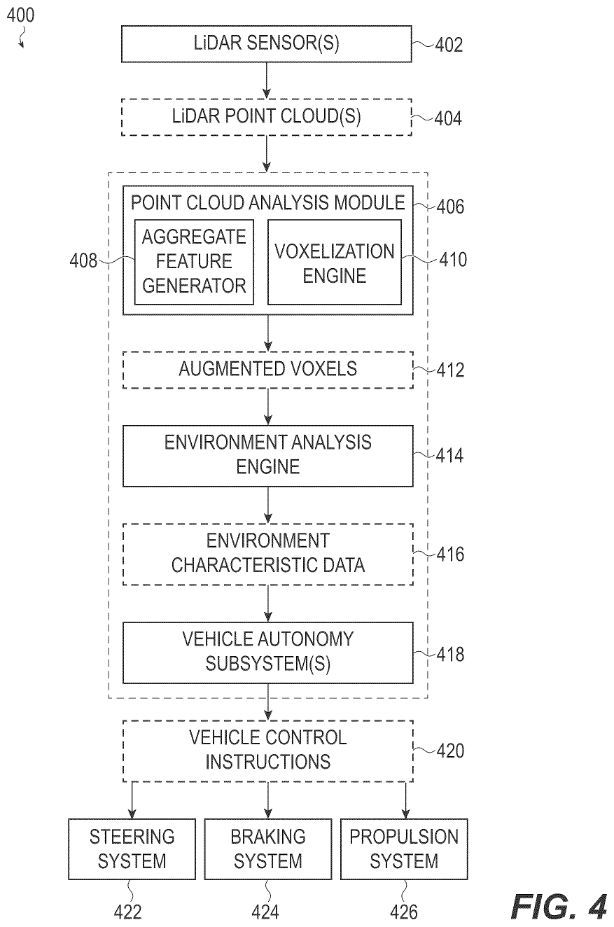

FIG. 4 is a system flow diagram 400 illustrating operations for generating and using augmented voxels in the operation of a vehicle and/or a transportation system. The operations may be executed by one or more systems described herein, including one or more vehicles, a transportation system controller, a dedicated LiDAR sensor (onboard a vehicle or a stationary installation). With respect to FIG. 4, one or more LiDAR sensor(s) 402 may generate one or more LiDAR point clouds 404. The LiDAR sensor(s) may include LiDAR modules (e.g., LiDAR modules that may be included in vehicles and/or roadway sensor modules) having LiDAR emitters and receivers.

The LiDAR point clouds 404 may be provided to a point cloud analysis module 406, which may include an aggregate feature generator 408 and a voxelization engine 410. The voxelization engine 410 may be configured to associate points of the LiDAR point cloud 404 with respective three-dimensional regions (e.g., voxels), as described herein. In some cases, the voxelization engine 410 may output voxels comprising all (or a statistically significant portion of) the LiDAR points in the three-dimensional region of the voxel, and/or voxels comprising downsampled sets of the LiDAR points in the three-dimensional region of the voxel. For example, the voxelization engine 410 may output an initial set of voxels that each include (or are associated with) all of the occupying LiDAR points, and these voxels may be provided to the aggregate feature generator 408. The aggregate feature generator 408 can then generate aggregate features for the voxels based on the full set of LiDAR points in that voxel. The voxelization engine 410 may also output downsampled voxels (e.g., voxels having a downsampled subset of the occupying LiDAR points) for use in generating the augmented voxels 412, as described herein. That is, the aggregate feature generator 408 and the voxelization engine 410 may be configured to communicate various information to one another to facilitate voxelization and generation of augmented voxels.

As mentioned, the aggregate feature generator 408 may be configured to generate aggregate features (e.g., aggregate features 312, including principal direction features 314 and intensity features 316, of FIGS. 3A-3E). Accordingly, the aggregate feature generator 408 may process all (or a statistically significant portion of) the LiDAR points within each voxel. The aggregate feature generator 408 may receive voxel data from the voxelization engine 410 (e.g., voxels and occupying LiDAR points). The aggregate feature generator 408 may output feature data generated therefrom (e.g., for combination with downsampled voxels by point cloud analysis module 406 to obtain augmented voxels 412).

It should be appreciated that all or a portion of the point cloud analysis module 406 may be instantiated within a vehicle, within a remote system (e.g., as part of a transportation control system as described with respect to FIG. 1B), or a combination thereof. As one nonlimiting example, the point cloud analysis module 406 may be part of a LiDAR sensor system that is integrated with a vehicle. As another non-limiting example, the voxelization engine 410 may be provided as a component of a LiDAR sensing module on a vehicle, while the aggregate feature generator 408 may be a component of a remote transportation control system. It should be appreciated that this is merely an example, and that the point cloud analysis module 406 may be instantiated in a variety of manners, such as within a distributed processing system spanning multiple vehicles and roadway systems, within a processing system for a single vehicle or roadway system, or any like arrangement.

The aggregate features generated by the aggregate feature generator 408 may be combined with, mapped to, or otherwise associated with respective voxels (e.g., downsampled voxels) generated by the voxelization engine 410 to obtain augmented voxels 412. The augmented voxels 412 may then be provided to an environment analysis engine 414 (e.g., with the various features and downsampled voxels formatted as combined data structures, separate data structures, etc., as described herein).

The environment analysis engine 414 may be configured to analyze and/or process augmented voxels 412 to identify characteristics of an environment, such as road conditions, other vehicles, pedestrians, and obstacles. Identified characteristics of the environment may be mapped (or otherwise associated with) to respective voxels in which they are identified. As a non-limiting example, the environment analysis engine 414 may analyze the augmented voxels generated with respect to the LiDAR point cloud depicted in FIGS. 3A-3E.

In some cases, the environment analysis engine may include one or more machine learning models (e.g., one or more environment analysis models) configured to identify characteristics of the environment using augmented voxels as described herein. In some cases, the machine learning models may be trained using sets of training data including historical augmented voxels having annotations identifying environmental characteristics therein. Accordingly, the augmented voxels described herein may be used as higher dimensionality input data for training and operating the environment analysis engine. This may, for instance, improve the efficiency and precision of a trained machine learning model used to analyze augmented voxels. However, it should be appreciated that the environment analysis engine may include any suitable system, such as machine learning models that are not trained using sets of training data including historical augmented voxels. In some cases, the environment analysis engine may include data interpretation, transformation, or other like preprocessing systems for ensuring input data (e.g., augmented voxels) are compatible with the systems of the environment analysis engine.

By training the environment analysis engine using training data including historical augmented voxels, the environment analysis engine's use of aggregate features to identify obstacles and characteristics within the environment may result in improved LiDAR sensing performance. For example, training data may include voxelized LiDAR point clouds, wherein the voxels each have (or are associated with) respective aggregate features (e.g., intensity features and principal direction features). In this way, not only do the augmented voxels described herein improve the real-time performance of an environment analysis engine, they may enrich or otherwise improve the training of machine learning models used in environment analysis. This may result, for instance, in improved granularity or specificity when the environment analysis engine identifies the presence of an object within a predicted or predetermined path of the vehicle, or any other characteristics of an environment. It should be appreciated that the environment analysis engine may in some cases be recursively or adaptively trained, such as using continual learning or other like retraining techniques.

As an example, the environment analysis engine 414 may determine that one or more augmented voxels correspond to a rear portion of a stopped vehicle. Accordingly, the environment analysis engine 414 may output an identification of a location of the vehicle, a tag indicating the vehicle, and/or other like information. In some cases, the environment analysis engine 414 may be configured to determine an estimated time to interception with detected obstacles based on a predicted or predetermined path of the vehicle (e.g., a time until a collision with a stopped vehicle may occur, or an anticipated velocity and steering angle reaching a road surface condition causing reduced traction). It should be appreciated that this is merely an example, and that the environment analysis engine 414 may determine any other like characteristics of the environment and their relationship to a vehicle (e.g., whether the vehicle will intercept or otherwise be affected by them).

The environment analysis engine 414 may accordingly generate environment characteristic data 416 for use by vehicle autonomy subsystems 418. For instance, in the foregoing example, the environment characteristic data 416 may include an identification of the stopped vehicle, a location of the stopped vehicle, an estimated time to interception, and/or other information. This information, provided as environment characteristic data 416, may be used by the vehicle autonomy subsystems 418 to avoid a collision (e.g., to avoid a collision with an obstacle positioned in a path of the vehicle). More specifically, the vehicle autonomy subsystems may generate vehicle control instructions 420 for the steering system 422, propulsion system 424, braking system 426, and/or any other system that may aid in the safe avoidance of the obstacle (e.g., by generating a vehicle control instruction that alters the vehicle path such that an obstacle is no longer at risk of being intercepted). In the foregoing example, this may include steering the vehicle away from the stopped vehicle, applying the brakes, accelerating, and/or any other suitable vehicle operations. As additional examples, the vehicle control instructions 420 may include instructions that change, modify, add, remove, or otherwise affect vehicle operational parameters, such as speed limits, turn radius limits, acceleration and/or deceleration limits, motor or wheel torque limits, and so on. As further examples, the vehicle control instructions 420 may be used to control any other aspect of the vehicle, such as the doors (e.g., to open/close the doors in response to detecting a passenger proximate and/or within the vehicle), vehicle lights (e.g., to activate/deactivate lights, such as to attract the attention of a passenger to their assigned vehicle and/or warn another vehicle about a detected condition), communications systems (e.g., to cause the vehicle to send information to another vehicle or transportation system component, such as information about an evasive maneuver or braking event, information about a detected condition, etc.). In this way, the identifications made by the environment analysis engine 414 may be used to generate vehicle control instructions configured to adjust an operation of the steering system, propulsion system, and/or the braking system of a vehicle, or to generate any other instructions for controlling any aspect of a vehicle and/or the transportation system.

It should be appreciated that the vehicle autonomy subsystems 418 may include systems that are onboard a vehicle, within a remote transportation control system, a combination of both, or any like arrangement that may suitably instruct the relevant vehicle systems (e.g., steering system 422, propulsion system 424, and/or braking system 426, among any other vehicle systems). It should be appreciated that the vehicle control instructions 420 may be directed to any systems associated with control of a vehicle, such as suspension control systems, doors, lighting systems, airbag systems, communications systems, and the like.

It should be appreciated that the techniques described herein for the generation and use of augmented voxels for environment analysis and vehicle control may be applied to various systems, and need not be limited to autonomous land transportation. For instance, the systems described herein may be used to improve the operation of autonomous freight equipment, topographical survey drones (or any other scanning, survey, or other LiDAR-based sensing implementation), aquatic vehicles, robots, robotic vehicles, aircraft, human-operated vehicles, and/or any other like system that may use LiDAR sensors to detect and/or analyze aspects of an environment.

Further, LiDAR module installations and the use of augmented voxels may be used in transportation systems for detecting other environments and/or environmental conditions. For example, LiDAR modules may be deployed in parking and/or maintenance facilities, and the augmented voxels and associated processing techniques may be used to identify and track the locations of vehicles, personnel, maintenance equipment, parking spot occupancy, etc. As another example, LiDAR modules may be deployed in boarding zones, and the augmented voxels and associated processing techniques may be used to identify and track the locations and/or paths of users within and/or throughout the boarding zones.

FIG. 5 is a schematic representation of a vehicle 500, illustrating an example set of systems that may facilitate and/or implement the operations and techniques described herein. Vehicle 500 may correspond to or be an embodiment of the vehicle 102, the vehicle 200, or any other vehicle described herein. The vehicle 500 may include a vehicle controller 520. The vehicle controller 520 may include a vehicle sensing subsystem 522, a vehicle communication subsystem 524, a vehicle autonomy subsystem 526, a vehicle controls subsystem 528, and a vehicle user interface (UI) subsystem 530. The vehicle controller 520 may be coupled to various physical and/or hardware components of the vehicle 500, including but not limited to propulsion system(s) 532, steering system(s) 534, braking system(s) 536, sensor(s) and/or sensing system(s) 538, door system(s) 540, user interface system(s) 542, and the like.

The vehicle sensing subsystem 522 may include or be coupled to sensing systems 538, which may include tri-band redundant sensing (LiDAR, radar, camera), providing high-resolution (e.g., about 0.2 to about 2.0 mrad), low-latency (e.g., less than about 100 ms latency), and long-range sensor data (e.g., greater than about 600 ft). The vehicle sensing subsystem 522 may provide and/or access sensor data that is used to determine vehicle state (e.g., position, velocity, acceleration) as well as to provide detection and localization of other objects in the system including other vehicles and any intrusions into the system. LiDAR systems and modules described herein may be part of the vehicle sensing subsystem 522 and/or the sensors 538.

The vehicle communication subsystem 524 may include dual-band redundant wireless communications. This subsystem may provide trajectory information (e.g., fully deconflicted vehicle trajectories) and movement authority signals to the vehicle (where the movement authority signal is a continuous signal required for any permissive state on the system). The vehicle communication subsystem 524 may also transmit vehicle state information to other system components (e.g., other vehicles and roadway systems), the CMS 114, monitoring systems 118, the dispatch system 116, etc.). The vehicle communication subsystem 524 may also transmit and/or receive redundant/diverse system observations (e.g., intrusion observations, vehicle observations, such as may be determined using LiDAR data) across the system.

The vehicle autonomy subsystem 526 may facilitate the autonomous operation of the vehicle 500 including assuring the safety of the vehicle 500 in varied conditions including any and all failures of off-vehicle components (e.g., the CMS 114, monitoring systems 118, the dispatch system 116, etc.). The vehicle autonomy subsystem 526 may use the output of the vehicle sensing subsystem 522 (either directly or after processing the output, e.g., using characteristics of an environment identified using augmented voxels) as input and, based at least in part on the output, provide vehicle ego-localization (e.g., the location of the vehicle 500 in space and/or with respect to the transportation system) and object detection/localization (including other vehicles and foreign objects on or adjacent to the roadway). The vehicle autonomy subsystem 526 may cross-check its ego-localization and object reports against diverse and redundant sources (e.g., reports from roadside monitoring systems and other vehicles) and may enforce safety invariants with respect to these results (e.g., maintaining safe separation distances, etc.). The vehicle may periodically (e.g., at a frequency of about 10 cycles per second) or otherwise provide both a current safe motion plan and a fail-safe motion plan to the vehicle controls subsystem 528 (to be executed in the event a motion plan is not received on subsequent cycles). In some cases, vehicle ego-location may be partially or wholly provided by a remote system.

The vehicle controls subsystem 528 may control vehicle systems (e.g., propulsion, braking, steering, doors, etc.) and may maintain the vehicle in a safe state. The vehicle controls subsystem 528 may include safety-critical software running on safety-critical processing hardware (e.g., checked-redundancy via dual lockstep processors). The vehicle steering and braking systems may support a fail-safe design with respect to a loss of signal from the vehicle controls subsystem 528 via hardware watchdog timers.

The vehicle UI subsystem 530 may facilitate user interactions within the vehicle including, without limitation, verifying passenger identity (via NFC scan), allowing the user to initiate the trip, and providing information to the user over the course of the trip (e.g., time to arrival, alert prior to arrival). The vehicle UI subsystem 530 may include displays, touchscreen displays, output systems (e.g., lights, speakers), user input systems (e.g., keyboard, buttons, microphones), as well as other possible user interface components or systems. In some cases, the UI subsystem 530 may generate notifications to passengers of the vehicle in response to changes in a vehicle's predicted path, such as those taken to avoid hazardous path surface conditions.

The vehicle UI subsystem 530 may provide various outputs to and accept various inputs from passengers during a trip. For example, during a trip, the vehicle UI subsystem 530 may communicate trip progress, display messages, and provide access to customer support.

In one example, once a rider enters the vehicle, the vehicle UI subsystem 530 may provide an audio and/or visual output prompting the passenger to identify themselves (e.g., to present a credential item, ticket, etc.). The vehicle UI subsystem 530 may also include an NFC antenna, optical scanner, or other system to allow the user to identify themselves or otherwise provide credentials to the system. After the passenger identifies themself, the vehicle UI subsystem 530 may provide audio and/or visual outputs indicating that doors will close (and optionally providing a countdown, such as a 3 second countdown). At any point, the passenger can interact with the vehicle UI subsystem 530 to stop the doors from closing. Once the doors are closed, the vehicle UI subsystem 530 may provide an audio and/or visual output indicating that departure is imminent.

During the trip, a progress bar or other trip progress information (e.g., a moving indication on a map of the roadway system) may be displayed to the user, via the vehicle's user interface and/or on the user's device. During the trip, the user may access customer support via the vehicle or their mobile phone or other device. Prior to arrival at a destination, the vehicle UI subsystem 530 may produce an audio and/or visual output indicating that they are about to arrive at their destination. A countdown may optionally be provided as well.

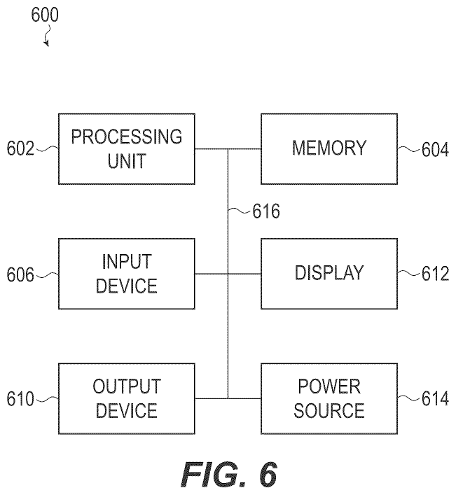

FIG. 6 illustrates a sample electrical block diagram of an electronic device 600 that may perform the operations described herein. The electronic device 600 may in some cases take the form of any of the electronic devices described herein, including the CMS 114, the monitoring systems 118, the dispatch system 116 (including trunk routers and node routers such as boarding zone routers, intersection routers, transition zone routers, etc.), vehicle controller 620, LiDAR sensor systems, vehicle user interfaces, boarding zone kiosks, portable electronic devices, or other computing devices or systems that are described herein or that are usable in order to perform the operations or instantiate the systems and/or services described herein. The electronic device 600 can include one or more of a display 612, a processing unit 602, a power source 614, a memory or storage device 604, input device(s) 606, and output device(s) 610. In some cases, various implementations of the electronic device 600 may lack some or all of these components and/or include additional or alternative components.

The processing unit 602 can control some or all of the operations of the electronic device 600. The processing unit 602 can communicate, either directly or indirectly, with some or all of the components of the electronic device 600. For example, a system bus or other communication mechanism 616 can provide communication between the processing unit 602, the power source 614, the memory 604, the input device(s) 606, and the output device(s) 610.

The processing unit 602 can be implemented as any electronic device capable of processing, receiving, or transmitting data or instructions. For example, the processing unit 602 can be a microprocessor, a central processing unit (CPU), an application-specific integrated circuit (ASIC), a digital signal processor (DSP), or combinations of such devices. As described herein, the term “processing unit” is meant to encompass a single processor or processing unit, multiple processors, multiple processing units, or other suitably configured computing element or elements.

It should be noted that the components of the electronic device 600 can be controlled by multiple processing units. For example, select components of the electronic device 600 (e.g., an input device 606) may be controlled by a first processing unit and other components of the electronic device 600 (e.g., the display 612) may be controlled by a second processing unit, where the first and second processing units may or may not be in communication with each other.

The power source 614 can be implemented with any device capable of providing energy to the electronic device 600. For example, the power source 614 may be one or more batteries or rechargeable batteries. Additionally, or alternatively, the power source 614 can be a power connector or power cord that connects the electronic device 600 to another power source, such as a wall outlet.

The memory 604 can store electronic data that can be used by the electronic device 600. For example, the memory 604 can store electronic data or content such as, for example, trip requests, user information, historical usage data, maps and/or layouts of the transportation system, vehicle data (e.g., information about each vehicle in the system, including assignment status, remaining charge, maintenance history, etc.), or the like. The memory 604 can be configured as any type of memory. By way of example only, the memory 604 can be implemented as random access memory, read-only memory, Flash memory, removable memory, other types of storage elements, or combinations of such devices.

In various embodiments, the display 612 provides a graphical output, for example, associated with an operating system, user interface, and/or applications of the electronic device 600. In one embodiment, the display 612 includes one or more sensors and is configured as a touch-sensitive (e.g., single-touch, multi-touch) and/or force-sensitive display to receive inputs from a user. For example, the display 612 may be integrated with a touch sensor (e.g., a capacitive touch sensor) and/or a force sensor to provide a touch- and/or force-sensitive display. The display 612 is operably coupled to the processing unit 602 of the electronic device 600.

The display 612 can be implemented with any suitable technology, including, but not limited to liquid crystal display (LCD) technology, light emitting diode (LED) technology, organic light-emitting display (OLED) technology, organic electroluminescence (OEL) technology, or another type of display technology. In some cases, the display 612 is positioned beneath and viewable through a cover that forms at least a portion of an enclosure of the electronic device 600.

In various embodiments, the input device(s) 606 may include any suitable components for detecting inputs. Examples of input device(s) 606 include light sensors, temperature sensors, audio sensors (e.g., microphones), optical or visual sensors (e.g., cameras, visible light sensors, LiDAR sensors and associated LiDAR emitters, or invisible light sensors), proximity sensors, touch sensors, force sensors, mechanical devices (e.g., crowns, switches, buttons, or keys), vibration sensors, orientation sensors, motion sensors (e.g., accelerometers or velocity sensors), location sensors (e.g., global positioning system (GPS) devices), thermal sensors, communication devices (e.g., wired or wireless communication devices), resistive sensors, magnetic sensors, electroactive polymers (EAPs), strain gauges, electrodes, and so on, or some combination thereof. Each input device 706 may be configured to detect one or more particular types of input and provide a signal (e.g., an input signal) corresponding to the detected input. The signal may be provided, for example, to the processing unit 602.

The output device(s) 610 may include any suitable components for providing outputs. Examples of output device(s) 610 include light emitters, audio output devices (e.g., speakers), visual output devices (e.g., lights or displays), tactile output devices (e.g., haptic output devices), communication devices (e.g., wired or wireless communication devices), and so on, or some combination thereof. Each output device 610 may be configured to receive one or more signals (e.g., an output signal provided by the processing unit 602) and provide an output corresponding to the signal(s).

In some cases, input device(s) 606 and output device(s) 610 are implemented together as a single device. For example, an input/output device or port can transmit electronic signals via a communications network, such as a wireless and/or wired network connection. Examples of wireless and wired network connections include, but are not limited to, cellular, Wi-Fi, Bluetooth, IR, and Ethernet connections.

The processing unit 602 may be operably coupled to the input device(s) 606 and the output device(s) 610. The processing unit 602 may be adapted to exchange signals with the input device(s) 706 and the output device(s) 610. For example, the processing unit 602 may receive an input signal from an input device 606 that corresponds to an input detected by the input device 606. The processing unit 602 may interpret the received input signal to determine whether to provide and/or change one or more outputs in response to the input signal. The processing unit 602 may then send an output signal to one or more of the output device(s) 610, to provide and/or change outputs as appropriate.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings. For example, while the methods or processes disclosed herein have been described and shown with reference to particular operations performed in a particular order, these operations may be combined, sub-divided, or re-ordered to form equivalent methods or processes without departing from the teachings of the present disclosure. Moreover, structures, features, components, materials, steps, processes, or the like, that are described herein with respect to one embodiment may be omitted from that embodiment or incorporated into other embodiments. Further, while the term “roadway” is used herein to refer to structures that support moving vehicles, the roadways described herein do not necessarily conform to any definition, standard, or requirement that may be associated with the term “roadway,” such as may be used in laws, regulations, transportation codes, or the like. As such, the roadways described herein are not necessarily required to (and indeed may not) provide the same features and/or structures of a “roadway” as defined or used in other contexts. Of course, the roadways described herein may comply with any and all applicable laws, safety regulations, or other rules for the safety of passengers, bystanders, operators, builders, maintenance personnel, or the like.

What is claimed is:

1. A vehicle comprising:
a set of wheels;
a propulsion system coupled to at least a subset of the set of wheels and configured to propel the vehicle;
a steering system coupled to at least a subset of the set of wheels and configured to steer the vehicle;
a braking system configured to decelerate the vehicle;
a light detection and ranging (LiDAR) emitter configured to emit light into an environment external to the vehicle and a LiDAR sensor configured to receive portions of the emitted light reflected by the environment; and
a processing system configured to:
accept, as input, a LiDAR point cloud, the LiDAR point cloud including points corresponding to respective received portions of the emitted light reflected by the environment;
identify a set of points of the LiDAR point cloud that are within a three-dimensional region of the environment;
generate a voxel direction feature using a respective position value of each point within a first collection of the set of points;
generate one or more voxel intensity features using a respective intensity value of each point within a second collection of the set of points;
perform a downsampling operation to obtain a third collection of points of the set of points;
generate an augmented LiDAR voxel corresponding to the three-dimensional region of the environment and comprising:
the voxel direction feature;
the one or more voxel intensity features; and
the third collection of points;
identify, using the augmented LiDAR voxel, a characteristic of the environment; and
adjust an operation of at least one of the propulsion system, the steering system, or the braking system in response to identifying the characteristic of the environment.

2. The vehicle of claim 1, wherein each of the first collection of the set of points and the second collection of the set of points each include a greater quantity of points than the third collection of points of the set of points.

3. The vehicle of claim 2, wherein the first collection of the set of points and the second collection of the set of points each comprise each point in the set of points.

4. The vehicle of claim 1, wherein the one or more voxel intensity features include:
an intensity histogram; and
an intensity standard deviation.

5. The vehicle of claim 1, wherein:
the three-dimensional region is defined by a boundary defining a rectangular prism; and
the augmented LiDAR voxel is a column voxel defined by the boundary.

6. The vehicle of claim 1, wherein identifying the characteristic of the environment includes using one or more additional augmented LiDAR voxels corresponding to one or more additional three-dimensional regions of the environment.

7. The vehicle of claim 1, wherein identifying the characteristic of the environment includes identifying a presence of an object in the environment that is within a predicted path of the vehicle.

8. A vehicle comprising:
a set of wheels;
a propulsion system coupled to at least a subset of the set of wheels and configured to propel the vehicle;
a steering system coupled to at least a subset of the set of wheels and configured to steer the vehicle;
a braking system configured to decelerate the vehicle;
a light detection and ranging (LiDAR) emitter configured to emit light into an environment external to the vehicle and a LiDAR sensor configured to receive portions of the emitted light reflected by the environment; and
a processing system configured to:
accept, as input, a LiDAR point cloud, the LiDAR point cloud including points corresponding to respective received portions of the emitted light reflected by the environment;
identify a set of points of the LiDAR point cloud that are within a three-dimensional region of the environment;
generate, using the set of points, an intensity feature representative of surface reflectances within the three-dimensional region;
generate, using the set of points, a direction feature representative of surface geometries within the three-dimensional region;
perform a downsampling operation to obtain a collection of points within the set of points;
generate, using the intensity feature, the direction feature, and the collection of points, an augmented LiDAR voxel;
identify, using the augmented LiDAR voxel, a characteristic of the environment; and
adjust an operation of at least one of the propulsion system, the steering system, or the braking system in response to identifying the characteristic of the environment.

9. The vehicle of claim 8, wherein identifying the characteristic of the environment includes:
providing the augmented LiDAR voxel as input to an environment analysis model; and
receiving, from the environment analysis model, an identification of the characteristic of the environment.

10. The vehicle of claim 9, wherein adjusting the operation of at least one of the propulsion system, the steering system, or the braking system in response to identifying the characteristic of the environment includes:
determining that the characteristic of the environment is an obstacle positioned in a path of the vehicle;
generating a vehicle control instruction configured to alter the path of the vehicle such that the obstacle is no longer positioned in the path; and
providing the vehicle control instruction to at least one of the propulsion system, the steering system, or the braking system.

11. The vehicle of claim 9, wherein the environment analysis model comprises a machine learning model trained using sets of training data including historical augmented voxels having annotations identifying environmental characteristics corresponding to the historical augmented voxels.

12. The vehicle of claim 11, wherein identifying the characteristic of the environment includes using one or more additional augmented LiDAR voxels associated with additional respective three-dimensional regions of the environment.

13. The vehicle of claim 8, wherein the intensity feature comprises a histogram of point intensities generated using the set of points of the LiDAR point cloud.

14. The vehicle of claim 13, wherein the downsampling operation comprises a stochastic discard operation.

15. A method for operating a vehicle having a LiDAR sensing system, the method comprising:
at a vehicle comprising:
a set of wheels;
a propulsion system coupled to at least a subset of the set of wheels and configured to propel the vehicle;
a steering system coupled to at least a subset of the set of wheels and configured to steer the vehicle;
a braking system configured to decelerate the vehicle;
a light detection and ranging (LiDAR) emitter configured to emit light into an environment external to the vehicle; and
a LiDAR sensor configured to receive portions of the emitted light reflected by the environment; and
a processing system:
generating a LiDAR point cloud, the LiDAR point cloud including points corresponding to respective received portions of light emitted by the LiDAR sensing system and reflected by an environment external to the vehicle;
identifying a set of points of the LiDAR point cloud that are within a three-dimensional region of the environment;
generating a voxel direction feature using a respective position value of each point within a first collection of the set of points;
generating one or more voxel intensity features using a respective intensity value of each point within a second collection of the set of points;
performing a downsampling operation to obtain a third collection of points of the set of points;
generating an augmented LiDAR voxel corresponding to the three-dimensional region of the environment and comprising:
the voxel direction feature;
the one or more voxel intensity features; and
the third collection of points;
identifying, using the augmented LiDAR voxel, a characteristic of the environment; and
adjusting an operation of at least one of the propulsion system, the steering system, or the braking system of the vehicle in response to identifying the characteristic of the environment.

16. The method of claim 15, wherein the vehicle is traveling on a predetermined path within the environment, and the characteristic of the environment is at least one of:
a path surface condition associated with reduced traction and positioned along a portion of the predetermined path; or
an object external to the vehicle and intersecting the predetermined path.

17. The method of claim 16, wherein adjusting an operation of at least one of the propulsion system, the steering system, or the braking system includes generating, at a user interface subsystem of the vehicle, a notification indicating a change in the predetermined path.

18. The method of claim 15, wherein:
the three-dimensional region is defined by a boundary defining a rectangular prism; and
the augmented LiDAR voxel is a column voxel defined by the boundary.

19. The method of claim 18, wherein the column voxel is positioned in a first voxel layer of a voxel lattice comprising a set of voxel layers, the first voxel layer defining a height of the boundary.

20. The method of claim 19, wherein identifying the characteristic of the environment includes using one or more additional augmented LiDAR voxels corresponding to one or more additional layers of the voxel lattice.

21. A vehicle comprising:
a set of wheels;
a propulsion system coupled to at least a subset of the set of wheels and configured to propel the vehicle;
a steering system coupled to at least a subset of the set of wheels and configured to steer the vehicle;
a braking system configured to decelerate the vehicle;
a light detection and ranging (LiDAR) emitter configured to emit light into an environment external to the vehicle and a LiDAR sensor configured to receive portions of the emitted light reflected by the environment; and
a processing system configured to:
accept, as input, a LiDAR point cloud, the LiDAR point cloud including points corresponding to respective received portions of the emitted light reflected by the environment;
identify a set of points of the LiDAR point cloud that are within a three-dimensional region of the environment;
generate a voxel direction feature using a respective position value of each point within a first collection of the set of points;
perform a downsampling operation to obtain a second collection of points of the set of points;
generate an augmented LiDAR voxel corresponding to the three-dimensional region of the environment and comprising:
the voxel direction feature; and
the second collection of points;
identify, using the augmented LiDAR voxel, a characteristic of the environment; and
adjust an operation of at least one of the propulsion system, the steering system, or the braking system in response to identifying the characteristic of the environment.

22. The vehicle of claim 21, wherein the first collection of the set of points includes a greater quantity of points than the second collection of points of the set of points.

23. The vehicle of claim 21, wherein identifying the characteristic of the environment includes:
providing the augmented LiDAR voxel as input to an environment analysis model; and
receiving, from the environment analysis model, an identification of the characteristic of the environment.

24. A vehicle comprising:
a set of wheels;
a propulsion system coupled to at least a subset of the set of wheels and configured to propel the vehicle;
a steering system coupled to at least a subset of the set of wheels and configured to steer the vehicle;
a braking system configured to decelerate the vehicle;
a light detection and ranging (LiDAR) emitter configured to emit light into an environment external to the vehicle and a LiDAR sensor configured to receive portions of the emitted light reflected by the environment; and
a processing system configured to:
accept, as input, a LiDAR point cloud, the LiDAR point cloud including points corresponding to respective received portions of the emitted light reflected by the environment;
identify a set of points of the LiDAR point cloud that are within a three-dimensional region of the environment;
generate one or more voxel intensity features using a respective intensity value of each point within a first collection of the set of points;
perform a downsampling operation to obtain a second collection of points of the set of points;
generate an augmented LiDAR voxel corresponding to the three-dimensional region of the environment and comprising:
the one or more voxel intensity features; and
the second collection of points;
identify, using the augmented LiDAR voxel, a characteristic of the environment; and
adjust an operation of at least one of the propulsion system, the steering system, or the braking system in response to identifying the characteristic of the environment.

25. The vehicle of claim 24, wherein the first collection of the set of points includes a greater quantity of points than the second collection of points of the set of points.

26. The vehicle of claim 24, wherein the one or more voxel intensity features include:
an intensity histogram; and
an intensity standard deviation.
